(19) United States
(12) Patent Application Publication
(10) Pub. No.: US 2024/0230163 A1
(43) Pub. Date: Jul. 11, 2024

(54) STRUCTURAL GUTTER SYSTEM FOR SOLAR PANEL ARRAY

(71) Applicant: RBI SOLAR, INC., Cincinnati, OH (US)

(72) Inventors: Frank Carl OUDHEUSDEN, Mont Vernon, NH (US); Christopher Thomas NEEDHAM, Cincinnati, OH (US)

(73) Assignee: RBI SOLAR, INC., Cincinnati, OH (US)

(21) Appl. No.: 18/286,963

(22) PCT Filed: May 14, 2021
(86) PCT No.: PCT/US2021/032476

§ 371 Date: Oct. 13, 2023

(51) Int. Cl. F24S 40/44; F24S 25/12

(52) U.S. Cl. CPC F24S 40/44; F24S 25/12

(57) ABSTRACT

A system for collecting precipitation falling on a solar canopy structure. The solar panels arranged in rows. Each row is tilted increasing sun exposure for solar energy collection. The rows are arranged such that two rows face each other forming a V-shape. Pairs of rows tilted towards each other are arranged together. A gutter is installed at the bottom of each “V” formed by two rows. The gutters collect precipitation, such as rain, snow, and ice that runs off of the solar panels. The gutter system collects the precipitation from each gutter and delivers the precipitation to the ground system. Various means are used for preventing precipitation from falling between the upper meeting point of two rows that meet on the higher side, including gaskets and additional gutters.

### TECHNICAL FIELD

The present application relates to solar canopy systems and roofing systems.

### BACKGROUND

Greenhouse gas emissions have been identified as a leading cause of global warming. In an attempt to curb greenhouse gas emissions and slow global warming, individuals, companies and governments are turning to renewable energy sources to provide energy with reduced or no greenhouse gas emissions. One source of renewable energy is solar energy that is collected by solar panels. Solar panels are installed in arrays (layouts of multiple solar panels) to increase the amount of energy collected at a site.

To decrease losses due to transmission, energy customers and utility providers are increasingly installing solar panel arrays near population centers. Two common locations for solar panel arrays are building rooftops and over parking lots. In parking lots a support structure is constructed on which the solar panels can be installed elevating them off of the ground. Cars can park underneath the solar panels when the solar panels are placed on an elevated structure. Installing solar panel arrays in parking lots can provide for covered parking for vehicles below.

### BRIEF DESCRIPTION OF THE DRAWINGS

FIG. 1 is a perspective view of a solar panel array with gutters.

FIG. 2A is a profile view of a solar panel array supported by purlins with gutters on the lower edge meeting of the solar panels and a gasket at the higher edge meeting of the solar panels.

FIG. 2B is a profile view of a solar panel array supported by gutters on the lower edge meeting of the solar panels and a gasket at the higher edge meeting of the solar panels and without purlins.

FIG. 3A is a profile view of a solar panel array supported by purlins with gutters on the lower edge meeting of the solar panels and gutters at the higher edge meeting of the solar panels.

FIG. 3B is a profile view of a solar panel array supported by gutters on the lower edge meeting of the solar panels and gutters at the higher edge meeting of the solar panels and without purlins.

FIG. 4A is a profile view of a solar panel array supported by purlins with gutters on the lower edge meeting of the solar panels and tall gutters at the higher edge meeting of the solar panels.

FIG. 4B is a profile view of a solar panel array supported by gutters on the lower edge meeting of the solar panels and tall gutters at the higher edge meeting of the solar panels and without purlins.

FIG. 5 is a perspective view of a solar panel array with gutters and pipes to carry collected precipitation to the ground.

FIG. 6 is a detail view of a solar panel gutter.

Various features of the technology described in the present disclosure will become more apparent to those skilled in the art from a study of the Detailed Description in conjunction with the drawings. Embodiments are illustrated by way of example and not limitation in the drawings. While the drawings depict various embodiments for the purpose of illustration, those skilled in the art will recognize that alternative embodiments may be employed without departing from the principles of the technology. Accordingly, while specific embodiments are shown in the drawings, the technology is amenable to various modifications.

### DETAILED DESCRIPTION

Solar panels are increasingly installed in urban areas close to the customers who consume the power generated by the solar panels. Solar panels need unobstructed sunlight for most of the day and in most seasons to function properly. Therefore, solar panels are often installed on building roofs, over parking areas and any other covered area.

When solar panels are installed over a parking area the solar panels are often placed on a structure that supports the solar panels above the parking area. The structure places the solar panels at a heightened elevation where the solar panel exposure to sunlight is unobstructed and also allows vehicles to park below the solar panels. The vehicles are shaded while parking and the solar panels generate power through collection of sunlight.

Solar panels are designed to withstand the weather patterns that they will experience while collecting sunlight. Weather patterns can include heat, cold, rain, snow, ice, and wind. Rain, snow, and ice slide off of the solar panels due to the inclination of the solar panels. The rain, snow, and ice then fall between the gaps in the solar panels on to the ground below.

The solar panels and the support structure may be used as a roof to protect things stored below from the elements. To protect the items below, the solar panels must be constructed in such a way as to prevent the rain, snow, and ice from falling below the roof. Additionally, it may be desirable to prevent rain, snow, and ice from falling off of the edges of the roof and potentially injuring those below.

A system for collecting rain, snow, and ice according to various embodiments is described below. According to one embodiment, the solar panels are angled in an alternating fashion so that a first row points to in one direction and the neighboring row points in the opposite direction creating a wave-like pattern. The angled panels have a sufficient slope that the rain, snow, and ice or precipitation run off of the solar panels and on to the ground without a collection system. The system described uses gutters to collect the rain, snow, and ice and carry it away from the solar panels and the roofline to the ground through a series of pipes.

According to a first embodiment, gutters are placed at the lower meeting point between the angled solar panels, thus collecting rain, snow, and ice as it slides off of the panel. A gasket is placed at the upper meeting point of the solar panels to stop rain, snow, ice, and water from leaking between the solar panels at the upper meeting point.

According to a second embodiment, gutters are placed at both the upper meeting point and the lower meeting point of the solar panels. The gutters collect the rain, snow, ice and water from the solar panels.

According to a third embodiment, traditional gutters are placed at the lower meeting point of the solar panels and tall gutters are placed at the upper meeting point of the solar panels. The traditional gutters and the tall gutters collect the rain, snow, ice, and water from the solar panels.

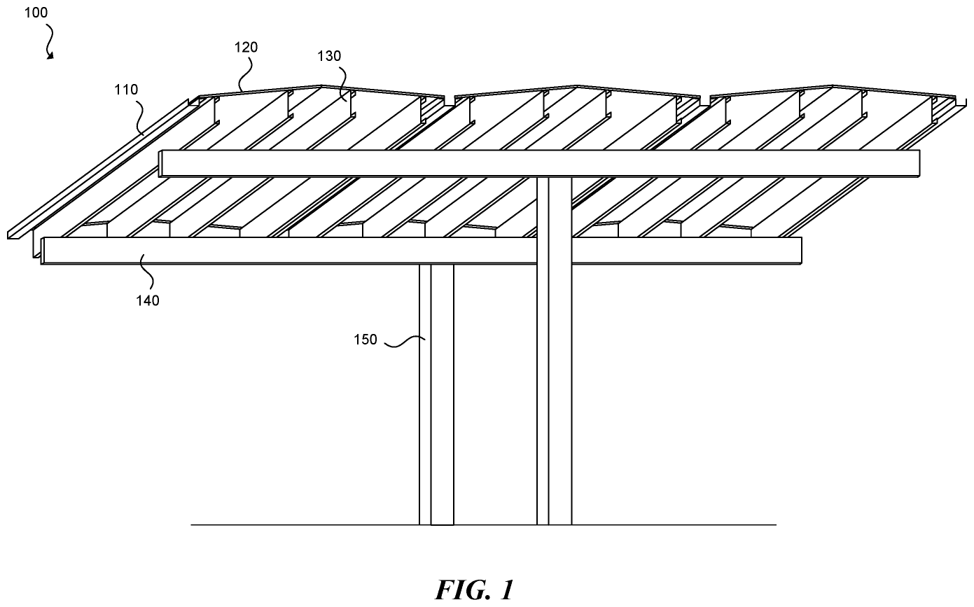

FIG. 1 is a perspective view of a solar panel array 100 with gutters 110. Solar panels 120 are arranged on a structure. The structure supporting the solar panels 120 consists of a column 150 that supports beams 140, that support purlins 130, that support solar panels 120. The column 150 can connect to a foundation at or below the ground surface and the columns 150 extend from the ground surface up to the beams 140. According to one embodiment the center of the beam 140 is connected to the top of the column 150. The solar panels 120 are arranged so that alternating rows of panels are angled in opposite directions. Alternating rows of panels decreases the wind loading experienced by the overall structure. A reduced wind load reduces the total load on the structure. Reducing loading on the overall structure reduces construction costs for the solar panel array. The support structure can be composed of lighter weight members and less expensive materials.

The rows of solar panels 120 are comprised of more solar panels 120 in a horizontal direction or along a longitudinal axis than in a vertical direction or along a narrow axis. The rows of solar panels 120 are parallel to the ground in the horizontal direction or along the longitudinal axis and tilted upward in the vertical direction or along the narrow axis. The beams 140 also run parallel to the ground surface. The purlins 130 support the solar panels 120 and are arranged to provide the tilt to the solar panels 120 in the vertical direction or along the narrow axis.

Gutters 110 are arranged down each row of solar panels 120. The gutters 110 are arranged at the lower edge of each row of solar panels 120 so that the gutters 110 can collect any rain, snow, or ice that runs off of the solar panels 120. The rain, snow, and ice runs off of the solar panels because of the vertical angle of the rows of solar panels 120. The gutters 110 run the full length of the solar panel 120 rows. The gutters 110 are arranged on the interior low points of the solar panel 120 rows and on the exterior low points of the solar panel 120 rows. The gutters 110 on the interior rows collect rain, snow, and ice from two rows of solar panels 120. The gutters 110 on the exterior rows collect rain, snow and ice from the outer row on the exterior of the array. The gutters 110 provide structural support to the solar panels 120, supporting the total load of the solar panels 120. The total load comprising the dead load and live load. The dead load comprising the weight of the solar panels 120 and the live load comprising a wind load, snow load or other transient load on the solar panels 120.

The column 150 and the beams 140 which support the solar panels 120 and the rest of the support structure can be constructed of metal. The columns 150 can be constructed of hot-rolled steel such as an I-beam or a hollow structured section tube (“HSS tube”), or other suitable hot-rolled sections. One or more beams 140 rest on the columns 150 to support the solar panels 120 and the purlins 130. The beams 140 can also be constructed of hot-rolled steel, using I-beams HSS tubes or other suitable hot-rolled sections. The beams 140 may also have a channel design with the channel facing upwards towards the solar panels 120.

According to another embodiment a smaller lighter weight support structure can be composed of cold-rolled steel. Cold-rolled steel has certain benefits over hot-rolled steel, such as reductions in overall assembly time and labor costs, customization, reductions in logistics costs, and manufacturing near the building site. Using cold-rolled steel is possible because the tilted solar panels 120, that are not parallel with the support structure, create reduced wind loads on the support structure. Cold rolled steel can be used for the columns 150, beams 140, and purlins 130.

The columns 150, beams 140, purlins 130, and solar panels 120 can be connected using a network of brackets, bolts, welds and various other fastening methods. The gutters 110 can be fastened directly to the solar panels 120 or can be supported by the beams 140. According to another embodiment, the support structure can be a truss design.

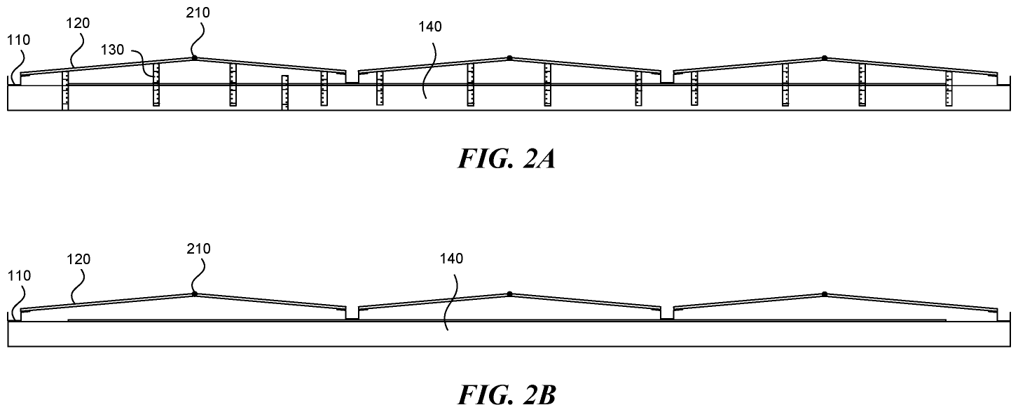

FIG. 2A is a profile view of a solar panel array supported by purlins 130 with gutters 110 on the lower edge meeting of the solar panels 120 and a gasket 210 at the higher edge meeting of the solar panels 120. According to one embodiment, the solar panels 120 are supported by purlins 130 that are supported by the beam 140. The rows of solar panels 120 can be positioned at angles to each other such that a first row angles upward meeting a second row at the upper edge of the solar panels 120 on the second row. The second row angles downward meeting a third row of solar panels 120. The second row and the third row meeting at a lower edge of the angled solar panels 120 in each row.

A gutter 110 can be installed at the lower meeting point of each of the solar panel rows. Additional gutters 110 can be positioned on the outside lower edges of solar panel rows that are on the edge of the solar panel array. The gutter 110 being comprised of aluminum, vinyl, copper, wood, stainless steel, polyvinyl chloride, sheet metal, rubber, or any other suitable material. The gutter 110 shaped to collect rain, snow, and ice as it runs off of the solar panels. The gutter 110 conducting the rain, snow, and ice to the ends of the solar panel rows. The gutter 110 can be part of a system that conducts the precipitation to the ground or the gutter 110 can have a downspout that allows the precipitation to travel directly to the ground from the end of the gutter 110.

According to one embodiment, the gutter 110 can provide structural support to the solar panels 120. The gutter 110 supporting the lower edge of each solar panel 120 row. The solar panels 120 receive additional support from the purlins 130. The network of gutters 110 and purlins 130 supporting the weight of the solar panels 120 and anchoring the solar panels 120 in wind loading or other environmental loading.

A gasket 210 can be installed at the upper meeting point or apex of the solar panel rows. The gasket 210 being comprised of rubber, polyurethane, adhesive, sealant, filler, fiber, putty, polyvinyl chloride, metal or any other suitable material. The gasket 210 configured to seal the gap between the rows of solar panels 120 and preventing rain, snow, and ice from running between the rows of solar panels 120 and dripping below the solar panels 120 and the support structure. The gasket 210 preventing precipitation from entering between the rows of solar panels 120. The gasket 210 can be flexible enough to contract and expand with movement of the solar panels 120 due to environmental conditions such as wind or expansion and contraction from heat and cold. The gasket 210 running the full length of the solar panel row and preventing the leakage of rain, snow, and ice from any point along the solar panel row.

The solar panel array 100 creates a continuous roofing structure. The solar panels 120 are installed so that precipitation does not leak through between the solar panels 120 in the row. Precipitation is also prevented from leaking through where the gutters 110 and gaskets 210 are installed. The continuous roofing structure provides the benefit of protecting items below it from precipitation.

FIG. 2B is a profile view of a solar panel array supported by gutters 110 on the lower edge meeting of the solar panels 120 and a gasket 210 at the higher edge meeting of the solar panels 120 and without purlins. According to one embodiment, the gutters 110 at the lower meeting point of the solar panels 120 and the gutters 110 on the outer rows of the solar panels 120 in the array provide structural support to the solar panels 120 in place of the purlins. The gutters 110 are supported by the beam 140. The gutters 110 support the lower edge of the solar panels 120. The angled solar panels 120 then rest against each other providing lateral support to the adjacent solar panel 120. The structural gutters 110 provide an added benefit of decreasing the cost of the solar panel array 100 by lowering construction costs. Fewer materials are needed because the solar panel array 100 can be constructed without the use of purlins. Additionally, labor costs will be reduced because purlins are not installed. According to some embodiments, additional structural elements can be included to support the solar panels 120. In particular, the additional structural elements can support the upper edges of the solar panels 120 near the gasket 210.

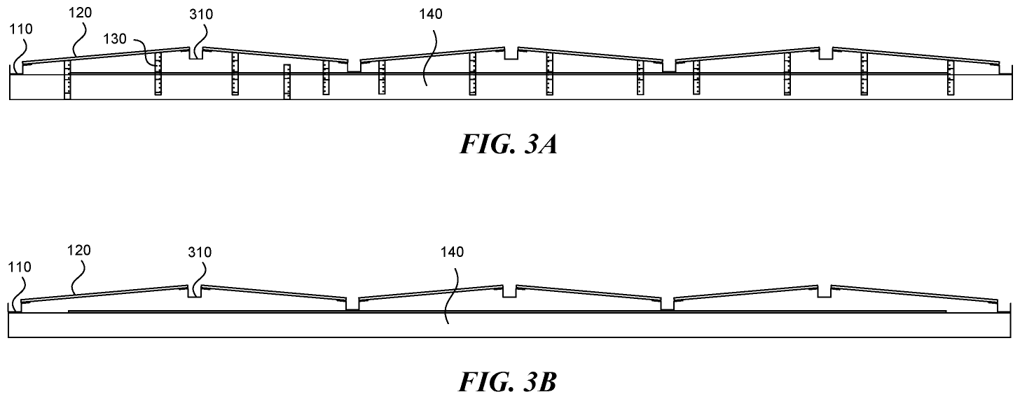

FIG. 3A is a profile view of a solar panel array supported by purlins 130 with gutters 110 on the lower edge meeting of the solar panels 120 and upper gutters 310 at the higher edge meeting of the solar panels 120. The solar panels 120 can be supported by purlins 130 and gutters 110 that are supported by a beam 140. The gutters 110 and upper gutters 310 can provide additional structural support to the solar panels 120 in addition to the purlins 130. The gutters 110, upper gutters 310 and purlins 130 sharing the total load from the solar panels 120. According to this embodiment, the gutters 110 are placed at the lower meeting point of the solar panel rows. Upper gutters 310 are also arranged at the upper meeting point of the solar panel rows. The upper gutters 310 extending the full length of the solar panel row. The upper gutters 310 collecting rain, snow, and ice and conducting the precipitation to the end of the row. The upper gutter 310 being comprised of aluminum, vinyl, copper, wood, stainless steel, polyvinyl chloride, sheet metal, rubber, or any other suitable material.

FIG. 3B is a profile view of a solar panel array supported by gutters 110 on the lower edge meeting of the solar panels 120 and upper gutters 310 at the higher edge meeting of the solar panels 120 and without purlins. The gutters 110 can provide structural support to the solar panels 120. The gutters 110 are supported by the beam 140. The upper gutters 310 can provide lateral structural support to the solar panels 120. The solar panels 120 are supported by the gutters 110 without the aid of purlins. According to one embodiment, the gutters 110 and the upper gutters 310 share the load from the solar panels 120. According to another embodiment, additional structural elements can be added to provide additional structural support to the solar panels 120.

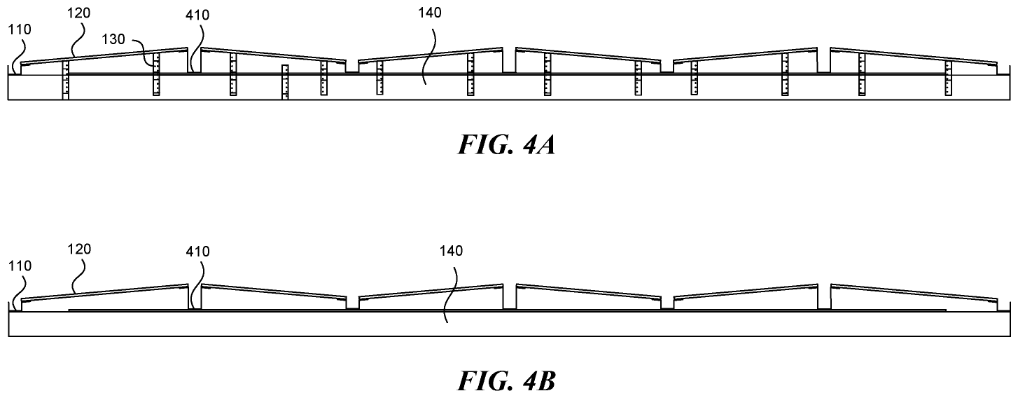

FIG. 4A is a profile view of a solar panel array supported by purlins 130 with gutters 110 on the lower edge meeting of the solar panels 120 and tall gutters 410 at the higher edge meeting of the solar panels 120. The solar panels 120 can be supported by purlins 130, the gutters 110 and the upper gutters 410 that are all supported by a beam 140. The gutters 110 and the upper gutters 410 can provide additional structural support to the solar panels 120. According to some embodiments, the purlins 130, gutters 110 and upper gutters 410 all provide varying percentages of structural support to the solar panels 120. The gutters 110 or upper gutters 410 could support a significantly lower percentage of the total load from the solar panels 120 than the purlins 130.

According to this embodiment, the tall upper gutters 410 are positioned at the upper edge meeting of the solar panel rows. The tall upper gutters 410 can be configured to have a height that extends from the lower edge of the solar panels 120 to the upper edge of the beam 140 so that the bottom of the gutter 410 rests on the upper surface of the beam 140. The beam 140 supporting the tall upper gutter 410. The tall upper gutter 410 collecting rain, snow, and ice. The tall upper gutter 410 conducting the precipitation to the edge of the solar panel row. The precipitation either falling from the tall upper gutter 410 to the ground or collected in a pipe system that conducts the precipitation to the ground surface.

FIG. 4B is a profile view of a solar panel array supported by gutters 110 on the lower edge meeting of the solar panels 120 and tall upper gutters 410 at the higher edge meeting of the solar panels 120 and without purlins. The solar panels 120 can be supported on their lower edge by the gutters 110 and laterally supported on their upper edge by the tall upper gutters 410. The gutters 110 and tall upper gutters 410 providing structural support so that the solar array can be constructed without the use of purlins. The gutters 110 and the tall upper gutters 410 are supported by the beam 140. According to one embodiment, the gutters 110 and the tall upper gutters 410 share the load from the solar panels 120. According to another embodiment, additional structural elements can be added to provide additional structural support to the solar panels 120.

Gutters at the lower connection between solar panel rows and at the upper connection between solar panel rows help to decrease the wind load by resisting the movement of the solar panel rows during a wind event. For example, when a first row experiences an upward lifting load from wind the gutter connection to the adjacent row of solar panels exerts a downward force on the first row. The opposite forces also help decrease the wind loading, for example, when a first row experiences a downward load from wind the gutter connection to the adjacent row of solar panels exerts an upward force on the first row.

The total load of the solar panels supported by the support structure is inclusive of the weight of the solar panels and any environmental loads experienced by the solar panels, such as wind and snow. The total load of the solar panels is shared by the gutters and purlins, if purlins are present. The portion of the total load that the gutters support is dependent on the particular embodiment of the solar panel array. In some embodiments, the gutters support a large portion of the total load, in other embodiments, the purlins support a large portion of the total load.

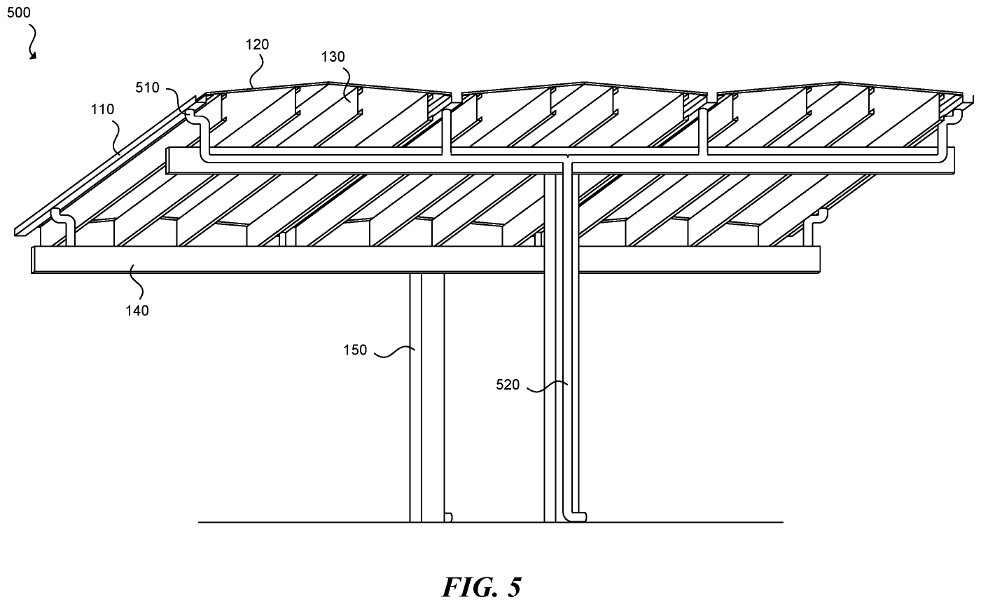

FIG. 5 is a perspective view of a solar panel array 500 with gutters 110 and a pipe system 510 and 520 to carry collected precipitation to the ground surface. According to one embodiment, the gutters 110 collect precipitation from the solar panels 120. The precipitation drains from the gutters 110 into a collection pipe 510. The collection pipe 510 running parallel to the beam 140. The precipitation then flows from the collection pipe 510 into the vertical pipe 520 and out onto the ground surface. The vertical pipe 520 runs perpendicular to the collection pipe 510 and parallel to the beam 140. The collection pipe 510 having one or more inlets connecting the collection pipe 510 to the gutter 110. The collection pipe 510 connecting to the vertical pipe 520 so that precipitation flows from the collection pipe 510 into the vertical pipe 520. The vertical pipe 520 having an outlet near the ground surface.

The collection pipe 510 and vertical pipe 520 are shown running alongside the beam 140 and column 150, respectively. The collection pipe 510 and vertical pipe 520 could conform to different arrangements than those shown in FIG. 5. The collection pipe 510 could be non-parallel with the beam 140. The collection system could include multiple vertical pipes 520, potentially one at the end of each gutter 110. The collection system with a vertical pipe 520 at the end of each gutter 110 would not have a collection pipe 550.

The collection pipe 510 and vertical pipe 520 are shown as circular pipes in FIG. 5. The collection pipe 510 and vertical pipe 520 could have a square, rectangular, oval, parallelogram or any other suitable cross-section. The collection pipe 510 and vertical pipe 520 can be comprised of aluminum, vinyl, copper, wood, stainless steel, polyvinyl chloride, sheet metal, rubber, or any other suitable material.

According to one embodiment, the collection pipe 510 is incorporated into the beam 140 and the vertical pipe 520 is incorporated into the column 150. The beam 140 and the vertical pipe 520 can be hollow to accommodate the precipitation flowing from the gutters 110 into the collection system.

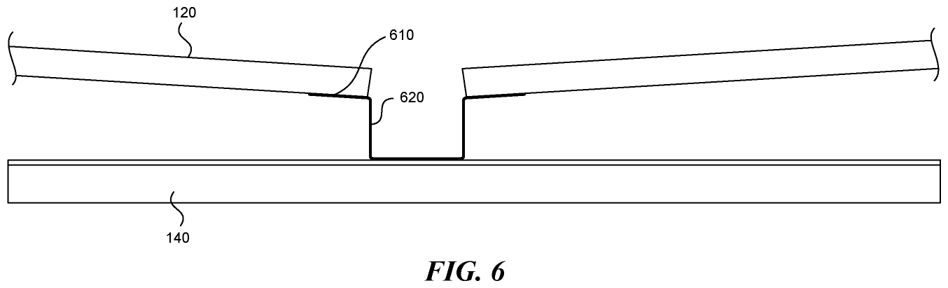

FIG. 6 is a detail view of a solar panel gutter 110. The gutter 110 is connected to the solar panel 120 at connection 610. The connection 610 is flush with the bottom of the solar panel 120. The connection 610 is a flange that extends from vertical sides of the solar panel gutter 110. The connection 610 can be at a right angle to the vertical sides or angled to accommodate the angle of the solar panel tilt. The gutter 110 is connected to the solar panel 120 using a fastener. The fastener comprising a screw, staple, nails, a welded connection, a hinge, an adhesive, or any other suitable fastener to attach the gutter 110 to the solar panel 120. The gutter 110 may rest on the beam 140 or hang from the bottom of the solar panels 120. The receptacle area 620 of the gutter 110 is shown as a rectangle but could be a square, semi-circular, a V-shape or any other suitable shape. The receptable area 620 is configured to receive precipitation as it drains off of the solar panels.

From the foregoing, it will be appreciated that specific embodiments of the invention have been described herein for purposes of illustration, but that various modifications may be made without deviating from the scope of the invention. Accordingly, the invention is not limited except as by the appended claims.

1. A gutter system for a solar panel array, comprising:
a canopy raised above the ground including a canopy beam forming a frame on at least two sides of the canopy, wherein the solar panel array forms a roof of the canopy; and
a first gutter, comprising:
a first side of the first gutter structurally supporting a first solar panel against the canopy beam;
a second side of the first gutter structurally supporting a second solar panel against the canopy beam; and
a precipitation channel disposed between the first side and the second side.

2. The gutter system of claim 1, further comprising:
a first flange on the first side of the first gutter, the first flange perpendicular to the first side and connecting the first side with the first solar panel; and
a second flange on the second side of the first gutter, the second flange perpendicular to the second side and connecting the second side with the second solar panel.

3. The gutter system of claim 1, wherein the first solar panel is tilted at a sloping angle causing precipitation to run off of the first solar panel into the first gutter, the second solar panel is tilted at a reflected sloping angle causing precipitation to run off of the second solar panel into the first gutter.

4. The gutter system of claim 3, wherein a total environmental load on the canopy is reduced by tilting the first solar panel at the sloping angle and tilting the second solar panel at the reflected sloping angle.

5. The gutter system of claim 1, wherein the canopy beams are structurally supported by at least two vertical columns connected a lower end to a foundational system.

6. The gutter system of claim 5, further comprising:
a plurality of purlins spanning between the canopy beams and providing structural support to the first solar panel and the second solar panel.

7. The gutter system of claim 6, wherein the first gutter provides structural support to a first portion of a total solar panel load and the plurality of purlins provides structural support to a second portion of the total solar panel load.

8. The gutter system of claim 1, further comprising:
a second gutter, comprising:
a first side of the second gutter structurally supporting a third solar panel against the canopy beam;
a second side of the second gutter structurally supporting a fourth solar panel against the canopy beam; and
a precipitation channel disposed between the first side and the second side; and
a gasket between the second solar panel and the third solar panel.

9. The gutter system of claim 1, further comprising:
a second gutter, comprising:
a first side of the second gutter structurally supporting a third solar panel against the canopy beam;
a second side of the second gutter structurally supporting a fourth solar panel against the canopy beam; and
a precipitation channel disposed between the first side and the second side; and
an apex gutter, comprising:
a first side of the apex gutter structurally supporting the second solar panel against the canopy beam;
a second side of the apex gutter structurally supporting the third solar panel against the canopy beam; and
a precipitation receiver channel disposed between the first side and the second side.

10. A gutter comprising:
a first lateral side connected to an edge of a first row of solar panels, the first lateral side bearing a solar panel first row total load;
a second lateral side connected to an edge of a second row of solar panels, the second lateral side bearing a solar panel second row total load; and
a horizontal channel disposed between the first lateral side and the second lateral side.

11. The gutter of claim 10, wherein the gutter is structurally supported by a structural frame, the structural frame comprising:
a first column, a first column lower end connected to a foundation system,
a second column, a second column lower end connected to the foundation system;
a first beam connected to a first column upper end;
a second beam connected to a second column upper end.

12. The gutter of claim 11, wherein the first row of solar panels is tilted so that precipitation runs off of the first row of solar panels into the gutter and the second row of solar panels is tilted in an opposite direction to the first row of solar panels so that precipitation runs off of the second row of solar panels into the gutter.

13. The gutter of claim 12, wherein a total environmental load on the structural frame is reduced by tilting the first row of solar panels in a first direction and tilting the second row of solar panels in an opposite direction.

14. The gutter of claim 10, further comprising:
a first projection on the first lateral side, the first projection fastened to the first row of solar panels;
a second projection on the second lateral side, the second projection fastened to the second row of solar panels.

15. A structural support gutter system, comprising:
a gutter disposed between a first row of solar panels and a second row of solar panels, the gutter adjacent to a solar panel first row long edge and a solar panel second row long edge, the gutter providing structural support to the first row of solar panels and the second row of solar panels, the gutter comprising:
a first side;
a second side; and
a precipitation channel; and
a support structure supporting the gutter, comprising:
a first beam connected to and structurally supporting a first end of the gutter;
a second beam connected to and structurally supporting a second end of the gutter;
a first column connected to and structurally supporting the first beam; and
a second column connected to and structurally supporting the second beam.

16. The structural support gutter system of claim 15, wherein the first row of solar panels comprises a grouping of solar panels that is one solar panel wide and more than one solar panel long.

17. The structural support gutter system of claim 16, wherein the second row of solar panels is equal in length and width to the first row of solar panels.

18. The structural support gutter system of claim 15, wherein the first row of solar panels is tilted that a first row edge proximal to the gutter is higher in elevation than a first row edge distal to the gutter.

19. The structural support gutter system of claim 15, wherein the second row of solar panels is tilted that a second row edge proximal to the gutter is higher in elevation than a second row edge distal to the gutter.

20. The structural support gutter system of claim 15, wherein the gutter further comprises:
a first flange on the first side, the first flange forming an angle with the first side and disposed along the first side, the first flange extending below the first row of solar panels and providing means to attach the first side to the first row of solar panels; and
a second flange on the second side, the second flange forming an angle with the second side and disposed along the second side, the second flange extending below the second row of solar panels and providing means to attach the second side to the second row of solar panels.

21. The structural support gutter system of claim 15, wherein the support structure supporting the gutter further comprises:
a plurality of purlins spanning between the first beam and second beam and providing structural support to the solar panel first row and the solar panel second row.

22. The structural support gutter system of claim 21, wherein the gutter provides structural support to a first portion of a total solar panel load and the plurality of purlins provides structural support to a second portion of the total solar panel load.
